(19) United States
(12) Patent Application Publication
(10) Pub. No.: US 2018/0355708 A1
(43) Pub. Date: Dec. 13, 2018

(54) PRODUCTION SITE MEMBRANE DEASPHALTING OF WHOLE CRUDE

(71) Applicant: ExxonMobil Research and Engineering Company, Annandale, NJ (US)

(72) Inventors: Benjamin A. McCool, Annandale, NJ (US); Michael C. Kerby, Basking Ridge, NJ (US); Vijay Swarup, Robbinsville, NJ (US)

(21) Appl. No.: 15/997,895

(22) Filed: Jun. 5, 2018

Related U.S. Application Data
(60) Provisional application No. 62/517,298, filed on Jun. 9, 2017.

(51) Int. Cl. E21B 43/40; C10G 31/00; B01D 71/02; B01D 61/02; B01D 69/02

(52) U.S. Cl. CPC E21B 43/40; C10G 31/00; E21B 43/16; B01D 61/027; B01D 69/02; B01D 71/02

(57) ABSTRACT

Systems and methods for deasphalting raw crude production product at the production site, e.g. at the wellhead, and injecting the retentate back into the reservoir are provided.

### CROSS-REFERENCE TO RELATED APPLICATIONS

This application claims priority to U.S. Provisional Application Ser. No. 62/517,298 filed Jun. 9, 2017, which is herein incorporated by reference in its entirety.

### FIELD

The present application relates to systems and methods for deasphalting raw crude production product at the production site, e.g. at the wellhead, using a membrane separation.

### BACKGROUND

A large proportion of currently produced crude oil streams are highly challenged—i.e. they include a high content of asphaltenes, metals, and micro carbon residue (MCR). These impurities can lead to a wide variety of refining issues that are well known in the art including corrosion and fouling of refinery components. Challenged crudes also introduced a host of challenges in desalting processes including, formation of emulsions resulting from precipitated waxes, asphaltenes, and inorganic metals. As the emulsion builds, salt removal and dehydration can be impacted, further contributing to downstream fouling and corrosion.

Current practices for dealing with high metal/high asphalt containing streams involve energy intensive separation techniques such as vacuum distillation and deasphalting as well as energy intensive conversion techniques like high pressure hydroconversion and coking. Moreover, it is believed that whole crude deasphaliting would be cost and energy prohibitive to practice in today's refineries. It would be beneficial to remove asphalt, metals, and other impurities from challenged crudes in a less costly and less energy intensive way. Additionally, it would be beneficial to perform this removal on whole crude without the need for processing prior to separation.

The present disclosure provides systems and methods for using membrane based hydrocarbon reverse osmosis of whole crude oils to remove metals, salts, and asphaltenic micro carbon containing molecules. In certain embodiments, these molecules are removed at the production site and reinjected into the subterranean formation such that they never reach the manufacturing/refining sites. By using small modular membrane based systems in the field, undesirable molecules in whole crude may be efficiently separated and reinjected. This flexible modular processing approach could lend itself to remote operations (e.g. off-shore) as well as short-term production schemes (e.g. shale oil).

### SUMMARY

Provided herein are methods and systems for desaphalting whole or raw crude at the production site using membranes. In one aspect, a method for desaphalting whole crude is provided, the method comprising producing a raw crude from a subterranean formation; introducing the raw crude to a membrane thereby producing a permeate stream and a retentate stream, wherein the permeate stream has a micro carbon residue content that is at least 70% lower than a micro carbon residue content of the raw crude. To the extent the raw crude includes an amount of water, said water can be separated from the raw crude via settling tank or other conventional means.

In certain embodiments the membrane is a ceramic or polymeric membrane with a molecular weight cut-off of about 8 kD or an average pore size from about 0.001 to about 0.020 microns (μm), e.g. about 0.002 to about 0.015 microns (μm), e.g. about 0.005 to about 0.010 microns (μm). The membrane will usually have a differential pressure from about 400 psi to about 3000 psi.

In another aspect, the permeate stream is substantially lower by weight percent than the raw crude in aromatics and other ringed molecules, especially those with a molecular weight greater than 500. For example the permeate stream may only include 10-40 wt % of the aromatics content of the raw crude and/or the permeate stream has a content of aromatics with a molecular weight greater than 500 that is at least 70% lower than a content of aromatics with a molecular weight greater than 500 of the raw crude. In yet another aspect, the permeate stream retains a significant amount of saturates and paraffins from the whole crude, e.g. about 75-97%, e.g. about 80-90%. In certain embodiments the permeate stream has a micro carbon residue content that is at least 80% lower than a micro carbon residue content of the raw crude. Additionally or alternatively, in other aspects, the permeate stream has an inorganic metals content that is at least 60% lower than an inorganic metals content of the raw crude. The permeate stream may be transported to at least one of a refinery, pipeline network, and storage facility.

In other aspects, the retentate stream has an average boiling point that is 500 to 700° F. higher than an average boiling point of the permeate stream. In certain embodiments the retentate stream has a saturates content that is about 5-20 wt. % of the saturates content of the raw crude. In yet another aspect, the method further comprises injecting the retentate stream in the subterranean formation. Prior to injection, at least one of a surfactant, alkali, and polymer can be added to the retentate stream to assist in enhanced oil recovery.

Also provided is a system for desasphalting a raw crude, the system comprising a well in fluid communication with a subterranean crude oil formation; wherein the well produces a raw crude from the subterranean crude oil formation; a membrane assembly in fluid communication with the well; wherein the membrane assembly comprises a retentate zone, a membrane, and a permeate zone; a conduit connecting the retentate zone and the subterranean crude oil formation to inject a retentate stream from the retentate zone to the subterranean crude oil formation; and a conduit connecting the permeate zone and a downstream facility to transport a permeate stream from the permeate zone to the downstream facility. The system is configured to carry out any of the above described methods.

### BRIEF DESCRIPTION OF THE DRAWINGS

FIG. 1 illustrates an embodiment of the present disclosure using a membrane in a filtration process for whole crude hydrocarbons.

FIG. 2 illustrates an embodiment of the present disclosure using a membrane in a filtration process for produced whole crude hydrocarbons and subsequent reinjection of a retentate stream into a subterranean reservoir.

FIG. 3 is a photograph showing the difference in retentate and permeate from an Arab Light crude oil run to 75% permeate yield on feed.

FIG. 4 graphically depicts the boiling point separation between retentate and permeate achieved from an Arab Light crude oil run to 75% permeate yield on feed.

FIG. 5 graphically depicts molecular speciation of separated Arab Light crude oil into permeate and retentate.

FIG. 6 graphically depicts compositional mapping of membrane separation products for Maya whole crude vs. prediction of molecules in propane asphalt using a conventional deasphalting method.

### DETAILED DESCRIPTION

### Definitions

In the following detailed description section, specific embodiments of the present techniques are described. However, to the extent that the following description is specific to a particular embodiment or a particular use of the present techniques, this is intended to be for exemplary purposes only and simply provides a description of the exemplary embodiments. Accordingly, the apparatuses and processes encompassed are not limited to the specific embodiments described below, but rather, include all alternatives, modifications, and equivalents falling within the true spirit and scope of the appended claims.

Unless otherwise explained, all technical and scientific terms used herein have the same meaning as commonly understood by one of ordinary skill in the art to which this disclosure pertains. The singular terms “a,” “an,” and “the” include plural referents unless the context clearly indicates otherwise. Similarly, the word “or” is intended to include “and” unless the context clearly indicates otherwise. The term “includes” means “comprises.” All patents and publications mentioned herein are incorporated by reference in their entirety, unless otherwise indicated. In case of conflict as to the meaning of a term or phrase, the present specification, including explanations of terms, control. Directional terms, such as “upper,” “lower,” “top,” “bottom,” “front,” “back,” “vertical,” and “horizontal,” are used herein to express and clarify the relationship between various elements. It should be understood that such terms do not denote absolute orientation (e.g., a “vertical” component can become horizontal by rotating the device). The materials, methods, and examples recited herein are illustrative only and not intended to be limiting

The term “raw crude” as used herein, means unrefined crude oil.

The term “Conradson Carbon Residue” (“CCR”) and “Micro Carbon Residue” (or “MCR”) as used herein are considered equivalents and is a measure of carbon content of a sample as measured per test method ASTM D4530.

The term “average boiling point” as used herein is defined as the mass weighted average boiling point of the molecules in a mixture. This may be determined by simulated distillation gas chromatography (also referred to herein as “SIMDIS”). The term “final boiling point” is defined as the temperature at which 95 wt % of the mixture is volatized at atmospheric (standard) pressure. All SIMDIS procedures were carried out according to test method ASTM D7169.

The term “membrane” as used herein, refers to organic solvent nanofiltration membranes and would include polymeric membranes, such as but not limited to, porous polytetrafluoroethylene (PTFE) and porous nylons, ceramic membranes, sintered metal membranes, porous glass membranes, polyimide/amide membranes, cross-linked polyimides, silicone, perfluorpolymers, or a combination thereof.

The term “ceramic” as utilized herein is defined as any hard, brittle, heat-resistant and corrosion-resistant material made by mixing, shaping and then firing to elevated temperatures a nonmetallic mineral or combination of minerals. Some preferred examples of ceramics and ceramic membrane modules that can be used in the present invention include, but are not limited to, monoliths, membranes, tubes, discs, sheets, layered structures, and other geometrical configurations known to those well versed in the state of the art. Preferred ceramics as used in the present invention are selected from materials comprised from clays, titania, silica, alumina, cordierite, ferric oxide, boron nitride, zirconia, zeolitic materials, glass, SiC, layered mineral structures, kaolinite, earthen ware materials, SO₂/Fe₂O₃, composites, layered structures comprising a combination of materials, foamed structures comprising a combination of materials, honey-combed configurations comprising a combination of materials, silicon nitride, solgel materials, steatite, porcelain, perovskites, macroporous and mesoporous materials, carbons, mixed matrix materials, and combinations thereof. Most preferably, the ceramics as used in the present invention are selected from materials comprised from clays, titania, silica, alumina, cordierite, ferric oxide, boron nitride, zirconia, zeolitic materials, glass, and SiC. The ceramic membranes disclosed herein may also be functionalized as described in U.S. Pat. No. 8,845,886 which is incorporated by reference in its entirety.

It is preferred that the membrane element have a certain pore size distribution. In certain aspects, the membrane element has an average pore size from about 0.001 to about 0.020 microns (μm); e.g., the membrane element has an average pore size from about 0.002 to about 0.015 microns (μm); e.g., the membrane element has an average pore size from about 0.005 to about 0.010 microns (μm). Additionally, the membrane element can be defined by molecular weight cut-off, such as an 8 kilodalton (kD) membrane. That is, molecules with a molecular weight less than the cut-off should pass through the membrane while molecules with a molecular weight greater than the cut-off should be rejected by the membrane.

Polymeric membranes often do not have a measurable pore size when they are not swollen by hydrocarbons. When they are swollen there is not an acceptable way to measure a pore size. Such membranes are typically characterized by molecular weight cut-off. Thus, in certain aspects, the membrane element has a molecular weight cut-off of about 250 daltons to about 1 kilodalton.

Unless otherwise noted, the term “hydrocarbon feedstream” or “hydrocarbon stream” as used herein is defined as a fluid stream that is comprised at least 80% hydrocarbon containing compounds by weight percentage. Unless otherwise noted, the term “heavy hydrocarbon” or “heavy hydrocarbon feedstream” as used herein is defined as a hydrocarbon containing composition wherein the final boiling point is above 950° F.

It has been discovered that conventional membranes can perform a deasphalting function on raw crude produced at the production site before the raw crude is exposed to any refining processes. Conventional solvent deasphalting is a refinery process for extracting asphaltenes and resins from heavy vacuum gas oil, atmospheric residue, vacuum residue, or other petroleum based materials to produce deasphalted oil that otherwise cannot be recovered from the residue by other refinery processes. By performing the deasphalting function on whole crude at the production site, this extra step of deasphalting can be minimized or avoided entirely. Surprisingly, as will be shown in the examples, the molecular weight distribution and aromaticity of the permeate products and retentate products obtained via production site membrane separation closely resembles the molecular weight distribution and aromaticity of the deasphalted oil product and pitch product, respectively, obtained via conventional solvent deasphalting.

The examples below show that membrane separations on whole crude results in a desirable, more easily refined permeate product and a retentate product, which can be sent to heavy oil refining processes more efficiently. Whole crude, of course, contains a variety of hydrocarbon molecules, such as saturates, paraffins, aromatics, and other ringed hydrocarbons, at various molecular weights. From a processing standpoint, hydrocarbon fractions that are higher in saturates and paraffin content are generally desirable as compared to hydrocarbon fractions that are high in aromatics and other ringed hydrocarbons. Likewise, lighter molecules are desirable as compared to heavier molecules. Moreover, it is also desirable to process hydrocarbon feeds that are lower in inorganic impurities such as sulfur, nickel, vanadium, sodium, calcium, iron, etc. Finally, reducing micro carbon residue (MCR), which is an indication of a material's coke-forming tendencies, is also desirable because a lower MCR feed is beneficial to reduce coking/fouling of refinery components.

We have found that membrane separations on whole crude across a range of API gravities can produce a permeate product high in saturates and paraffins while dramatically reducing inorganic species content and MCR. As shown in the examples below, the permeate product retains about at least 80%, e.g. at least 85%, at least 90%, or 80-100%, 80-95%, 85-95%, of all saturates and at least 80%, e.g. at least 85%, at least 90%, or 80-100%, 80-95%, 90-99%, of all paraffins from the incoming whole crude feed. The permeate product as compared to the whole crude feed is reduced in aromatics content by at least 30%, e.g. at least 40%, at least 70%, or 30-80%, 40-80% or 50-80% and other ringed molecules by at least 20%, e.g. at least 30%, at least 40%, or 20-60%, 30-50% or 40-50%. The permeate produce is even more selective for lower molecular weight (less than 250) molecules. About 90-99% of saturates and paraffins with molecular weights less than 250 are retained in the permeate product from the whole crude feed. Conversely, higher molecular weight (greater than 500) molecules are scarce in the permeate product. Only about 15-35% of aromatics and other ringed molecules with a molecular weight greater than 500 are retained in the permeate product from the whole crude feed. MCR in the permeate product is typically reduced by about 70-95%, e.g. 80-95%, or 80-90%, as compared to the whole crude feed. Sulfur is in the permeate product is typically reduced by 20-40%, e.g. 30-40%, while other organic impurities, such as nickel, vanadium and other metals, are reduced by as much as 60-95% as compared to the whole crude feed. Although all of the percentages above are to the permeate product, it would be understood by a person of skill in the art that the complimentary percentages would apply to the retentate product, i.e. 85% in the permeate would correspond to 15% in the retentate, and so on.

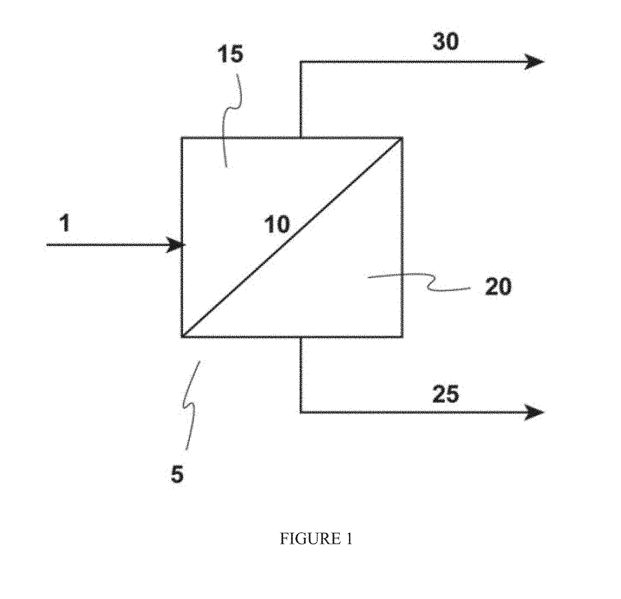

An embodiment of a process utilizing the present invention is illustrated in FIG. 1. Here, a hydrocarbon stream (1) is fed to a filtration unit (5) which contains one or more membrane elements. In certain embodiments, the hydrocarbon stream (1) is comprised of heavy hydrocarbon feedstreams, wherein the final boiling point the heavy hydrocarbon feedstream is greater than about 950° F. Such feedstreams include, but are not limited to, whole crudes, shale oils, oils derived from bitumens, and oils derived from tar sands, as well as similar heavy hydrocarbon raw feedstocks. In a preferred embodiment, the filtration unit (5) is co-located with the wellhead such that the hydrocarbon stream does not undergo any processing or refining prior to entering the filtration unit (5).

Continuing with FIG. 1, the filtration unit (5) contains at least one membrane element (10), a retentate zone (15) wherein the hydrocarbon feedstream (1) contacts a first side of membrane (10), and a permeate zone (20), from which at least one permeate product stream (25) is obtained from the opposite or second side of membrane (10). Such permeate product stream (25) obtained is comprised of materials that selectively permeate through the membrane element (10). In certain embodiments, the heavy hydrocarbon feedstream may be flowed across the face of the membrane element(s) in a “cross-flow” configuration. In this configuration, in the retentate zone (15), the heavy hydrocarbon feed (1) contacts one end of the membrane element (10) and flows across the membrane, while a retentate product stream (30) is withdrawn from the other end of the retentate zone (15). As the feedstream/retentate flows across the face of the membrane, a composition selective in saturated compounds content flows through the membrane to the permeate zone (20) wherein it is drawn off as a permeate product stream (25). In a cross-flow configuration, it is preferable that the Reynolds number in at least one retentate zone (15) of the membrane separations unit (5) be in the turbulent range, preferably above about 2000, and more preferably, above about 4000. In some embodiments, a portion of a retentate stream obtained from the membrane separation units may be recycled and mixed with the feedstream to the membrane separations unit prior to contacting the active membrane.

Although it is not believed to be necessary to obtain the separations results shown herein, it is preferable that the pressure across the membrane element (10) filter element be above about 400 psi, especially when the hydrocarbon feedstream is comprised of heavy hydrocarbon components. It is believed herein that selective separation of certain stream components (including MCR) may be enriched at these higher filtration pressures. Preferably the pressure across the membrane is at least 400 psi, e.g. at least 7000 psi, at least 1200 psi, or at least 1500 psi. The preferred ranges of the pressure across the membrane element (10) (or pressure drop) for operation of the present invention are about 400 to about 3000 psi, e.g. about 500 to about 2500 psi, about 700 to about 1500 psi.

Also, in other embodiments of the present invention, the temperatures of the heavy hydrocarbon feedstream when contacting the filter element(s) is from about 50 to about 350° C., e.g. about 100 to about 300° C. For heavy hydrocarbon feedstreams, a preferred temperature is about 100 to about 250° C. The current invention can operate at feedstream temperatures above 350° C., but it is preferred that the feedstream be below a temperature wherein thermal cracking of the feedstream is minimized.

Continuing with FIG. 1, the current invention utilizes a filtration process to separate the feedstream into at least one permeate product stream (25) that is reduced in MCR content with respect to the feedstream and at least one retentate product stream (30) is drawn from the retentate zone (15) of the filtration unit (5) which is increased in MCR content with respect to the feedstream. It should be understood that depending upon more complex arrangements such as multiple internal stages, series or parallel multiple unit operations, and/or filtration unit configurations knowledgeable to those skilled in the art, that more than one filtration element and/or filtration zone may be utilized and that more than one permeate product stream and/or retentate stream may be obtained from the filtration unit (5). Additionally, the retentate product stream (30), permeate product stream (25) or any portions thereof may be recycled to the primary retentate zone or any intermediate retentate zone.

In a preferred embodiment, filtration unit (5) is co-located at the production site and the retentate product stream (30) is reinjected into the subterranean reservoir. Reinjecting retentate product stream (30) into the reservoir will result in enhancements to well production efficiency including but not limited to maintaining reservoir pressure to optimize production over its lifetime and/or use of retentate components with or without enhanced oil recovery (EOR) fluids (e.g. surfactants, polymers, alkali, etc.) for enhanced oil recovery operations.

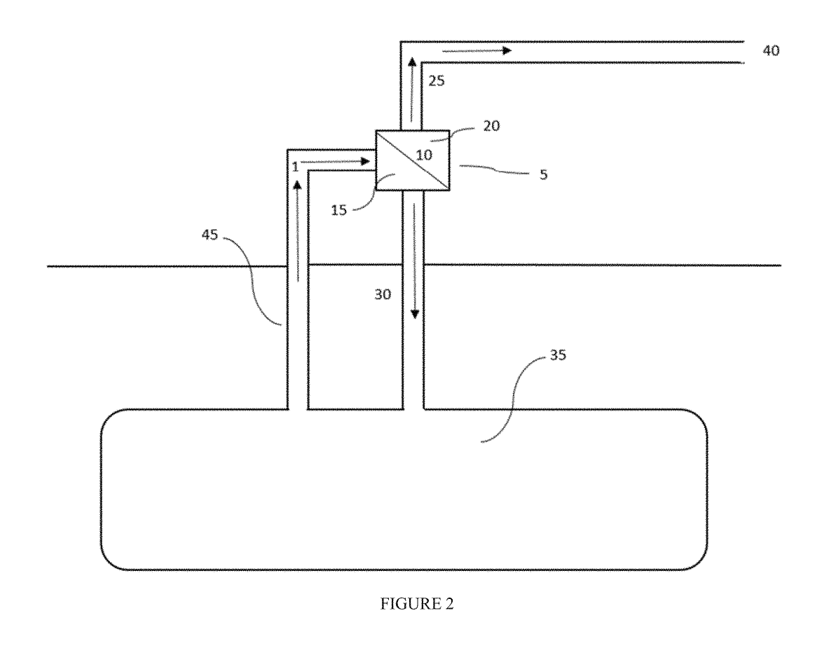

FIG. 2 illustrates this system. Hydrocarbon stream (1) is produced from reservoir (35) via well (45). Hydrocarbon stream (1) is fed to a filtration unit (5). Filtration unit (5) contains at least one membrane element (10), a retentate zone (15) wherein the hydrocarbon stream contacts a first side of membrane (10), and a permeate zone (20), from which at least one permeate product stream (25) is obtained from the opposite or second side of membrane (10). The permeate product stream (25) obtained is comprised of materials that selectively permeate through the membrane element (10). The permeate product stream (25) is the transferred to downstream components (40), which could be a refinery, storage vessel (on land or sea), pipeline network, etc.

Retentate product stream (30) is reinjected into reservoir (35). This helps to maintain reservoir (35) pressure and/or allows the use of retentate fractions for enhanced oil recovery operation. For example, in certain embodiments, retentate product stream (30) is mixed with enhanced oil recovery fluids (e.g. surfactants, polymer, and/or alkali) prior to reinjection for enhanced oil recovery. Surfactants are commercially manufactured typically from alcohols, which are chemically modified to append a hydrophilic head group, such as a carboxylic acid, sulfonate, sulfate, phosphate or amine group, to a hydrophobic tail.

### Example 1: Whole Crude Separations at 75% Permeate Yield

Various whole crude oils were separated using ceramic membranes having pore size distribution from 1-10 nm at temperatures between 50-200° C. and transmembrane pressures between 500-1500 psig. Arab Light, Maya, Cold Lake, Bach-Ho, and Eagle Ford whole crudes were tested. The whole crudes were run through the membrane at transmembrane pressures sufficient to produce a 75% permeate yield by weight on feed. None of these samples were desalted prior to membrane testing. MCR is retained in the 80-90% range, with retained nickel and vanadium in the 90% range. The results are shown in Table 1 below:

TABLE 1

| Crude | MCR Retained |
|---|---|
| Arab Light | 91% |
| Maya | 92% |
| Cold Lake | 81% |
| Bach-Ho | 84% |
| Eagle Ford | 83% |

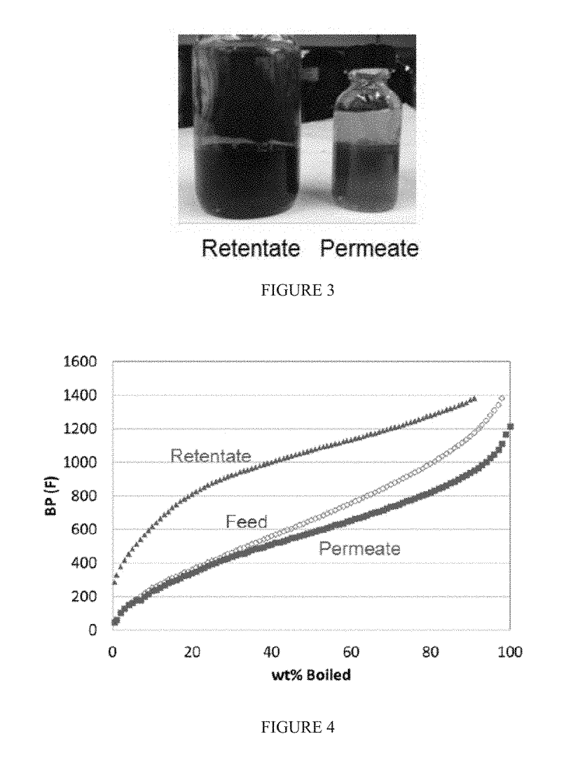

FIG. 3 provides a photograph of the resulting permeate and retentate product streams of the Arab Light crude oil run to 75% permeate yield on feed. This figure qualitatively shows the ability of the ceramic membrane to significantly upgrade the produced whole crude.

Additional separations were conducted on Arab Light whole crude using a variety of different membranes and operating

### Example 2: Whole Crude Separation at Various Permeate Yields

A sample of Eagle Ford whole crude was separated using ceramic membranes having pore size distribution centered at 2 nm at a temperature of 100° C. and transmembrane pressures of 400 psig. The Eagle Ford sample was run through the membrane to produce a 90% permeate yield by weight on feed. In all of the examples below, elemental analysis (Ca, Fe, Na, Ni, Va, and Z) was measured via inductively coupled plasma (ICP) mass spectroscopy. The results are depicted in Table 2 below.

TABLE 2

| Description | EF-Feed | EF-Permeate | % Reduction |
|---|---|---|---|
| API Density | 42.4 | | |
| Calcium (ppm) | 13.2 | 1.52 | 88.5 |
| Iron (ppm) | 14.2 | 1.52 | 89.3 |
| Sodium (ppm) | 32.1 | 10.6 | 67.0 |
| Nickel (ppm) | 1.30 | 0.38 | 70.8 |
| Vanadium (ppm) | 8.79 | 1.6 | 81.8 |
| Zinc (ppm) | 5.17 | 0.22 | 95.7 |
| MCR (%) | 1.20 | 0.20 | 83.3 |

It can be seen that not only is micro carbon rejected from the Eagle Ford shale oil, but the membrane also rejects the majority of inorganic species in the whole crude. The sample was not desalted prior to membrane testing.

A sample of Maya crude was separated using an 8 kD ceramic membrane at a temperature of 200° C. and transmembrane pressures of 600 psig. The Maya sample was run through the membrane to produce a 50% permeate yield by weight on feed. Sulfur was determined via ASTM 2622-16. The results are depicted in Table 3 below.

TABLE 3

| Description | Maya-Feed | Maya-Permeate | % Reduction |
|---|---|---|---|
| API Density | 21.5 | | |
| Sulfur (wt %) | 3.72 | 2.44 | 34.4 |
| Nickel (ppm) | 60 | 13 | 78.3 |
| Vanadium (ppm) | 302 | 38 | 87.4 |
| MCR (%) | 12.5 | 2.55 | 79.6 |

It can be seen that not only is micro carbon rejected from the Maya crude oil, but the membrane also rejects a significant amount of inorganic species such as sulfur, nickel, and vanadium. The sample was not desalted prior to membrane testing.

Samples of Arab Light crude (API gravity of about 32.8) were separated using various membranes at different temperatures. The Arab Light samples were run through the membranes to produce a 75% permeate yield by weight on feed. The results are depicted in Table 4 below.

TABLE 4

| | | MCR | Sulfur | Ni | V |
|---|---|---|---|---|---|
| Conditions | Streams | (%) | (wt %) | (ppm) | (ppm) |
| Arab Light, Evonik | Feed | 4.495 | 1.8 | 6 | 15 |
| Selective, 100° C., | Permeate | 0.521 | 1.279 | 2.143 | 1.224 |
| 600 psig | % Reduction | 88.4 | 28.9 | 64.3 | 91.8 |
| Arab Light, Evonik | Feed | 4.495 | 1.8 | 6 | 15 |
| Flux, 100° C., | Permeate | 0.686 | 1.383 | 0.641 | 0.897 |
| 600 psig | % Reduction | 84.7 | 23.2 | 89.3 | 94.0 |
| Arab Light, Evonik | Feed | 4.495 | 1.9925 | 6 | 15 |
| 600, 100° C., | Permeate | 0.536 | 1.398 | 1.065 | 1.935 |
| 600 psig | % Reduction | 88.1 | 29.8 | 82.3 | 87.1 |
| Arab Light, Evonik | Feed | 4.495 | 1.9925 | 6 | 15 |
| Flux, 75° C., | Permeate | 0.495 | 1.413 | 0.796 | 1.032 |
| 600 psig | % Reduction | 89.0 | 29.1 | 86.7 | 93.2 |
| Arab Light, Evonik | Feed | 4.495 | 1.9925 | 6 | 15 |
| Performance, | Permeate | 0.422 | 1.508 | 0.779 | 1.948 |
| 75° C., 600 psig | % Reduction | 90.6 | 24.3 | 87.0 | 87.0 |
| Arab Light, 8 kD | Feed | 4.55 | 1.9925 | 9.2 | 20.4 |
| ceramic, 100° C., | Permeate | 0.408 | 1.391 | 2.389 | 0.885 |
| 600 psig | % Reduction | 91.0 | 30.2 | 74.0 | 95.7 |

It can be seen that not only is micro carbon rejected from the Arab Light oil, but the membranes also rejects significant amounts of inorganic species in the whole crude such as sulfur, nickel, and vanadium. The percent rejection remains fairly constant across different temperatures and using different commercially available membranes. The samples were not desalted prior to membrane testing.

### Example 3: Boiling Point Separation of Arab Light Crude

In addition to inorganic species and MCR reduction, the membrane separations described herein also perform a boiling point separation without vaporizing any of the species in the crude oil. FIG. 4 shows the simulated distillation curves for an Arab Light crude oil separated with a ceramic membrane having a 2 nm average pore size distribution at 150° C. and 600 psig transmembrane pressure. This run was again taken to 75% permeate yield on feed. The membrane separation achieves around a 600° F. boiling point separation between permeate and retentate.

### Example 4: Molecular Weight Vs. Aromaticity/Rejection of Separated Arab Light Crude

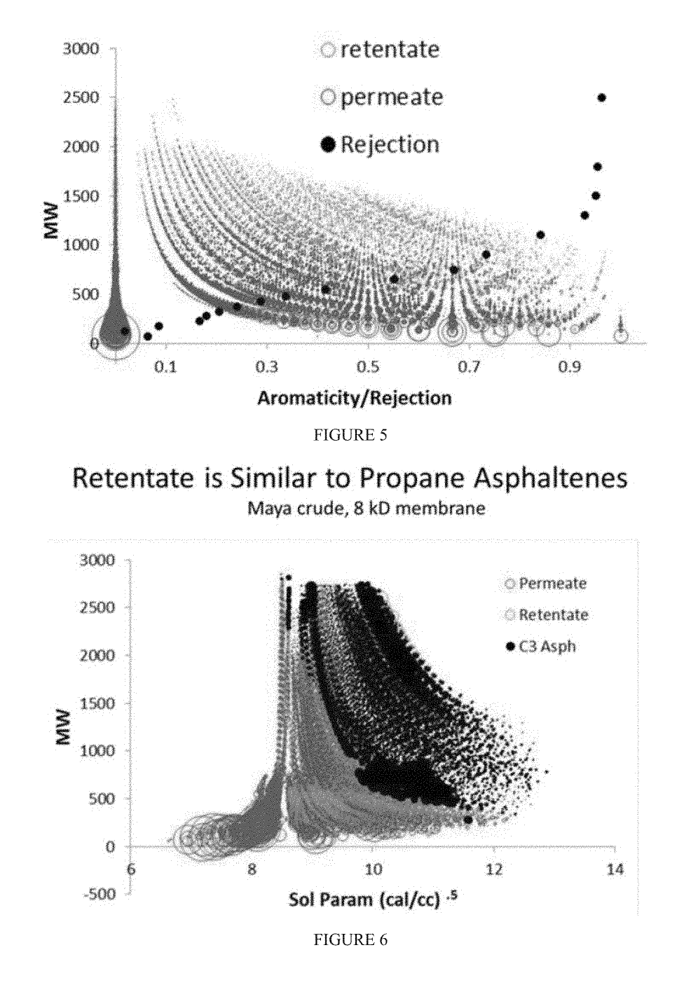

FIG. 5 shows the molecular weight distribution permeate and retentate molecules as well as aromaticity/rejection for the Arab Light crude oil separation described in Examples 1 and 3, Table 1, and FIGS. 3 and 4. Aromaticity of the molecules is assigned a value between 0 and 1 based on the % of aromatic carbons. For example, a molecule made of only aromatic carbon, e.g. benzene, would have an aromaticity of 1, a molecule with no aromatic carbon, e.g. hexane, would have an aromaticity of 0, and a molecule with some aromatic carbon, e.g. cyclohexylbenzene, would have an aromaticity of 0.5. Rejection is assigned a value between 0 and 1. Rejection is calculated based on equation 1

$${R}_{i} = 1 - ( \frac{{C}_{i , p}}{{C}_{i , r}} ) \qquad ( Equation 1 )$$

where R is the rejection for component i, C is the concentration of component i, p is the permeate and r is the retentate. A rejection of 1 would mean that molecule is completely rejected In FIG. 5 the larger the circle indicates a greater concentration of that particular molecule. As shown, molecules with low aromaticity and low molecular weight dominate the permeate stream. Fairly aromatic molecules can make their way into the permeate stream provided their molecular weight is low, e.g. between 10 and about 600 and preferably less than 500, e.g. less than 400. FIG. 5 clearly illustrates that there is strong molecular weight rejection, but there is also a preferential selectivity for saturates (molecules located at 0 on the x-axis). Without being bound by theory, it is believed that this selectivity is due to conformational flexibility (reputation) of paraffins and other saturates and the fact that they often have one dimension on the order of a methyl group or cyclohexyl group. Of significance, the molecules that are rejected from the whole crude closely resemble those that would be removed by conventional deasphalting processes.

### Example 5: Compositional Mapping of Permeate/Retentate of Maya Crude Separation as Compared to Conventional Solvent Deasphalting

FIG. 6 and Table 5 show an approximations of the molecules that would be expected to be removed by propane solvent deasphalting (SDA) against the molecules that are separated via membrane. Solvent deasphalting is a separation process in which residues are selectively separated by molecular type by mixing with paraffinic solvents and precipitating out of solution asphaltenes and other residue heavy components. SDA produces a low-contaminant, relatively high hydrogen deasphalted oil product and a pitch product that contains the majority of the residue's contaminants (metals, asphaltenes, MCR). FIG. 6 and Table 5 are data on the actual separation of Maya crude with a composite ceramic membrane made from alumina and titanic, having a nominal pore size of 2 nm operating at 150° C., 600 psig, and 75% permeate yield as compared to a modeled solvent (propane) desasphalting of the same crude. The model is based on computed differences in the Scatchard Hildebrand solubility parameters of molecules in the crude oil vs. the deasphalting solvent, in this case propane.

TABLE 5

| | Retentate | Model C3 Asph |
|---|---|---|
| Sats | 4.1 | 0 |
| Arom | 32.1 | 24.3 |
| Sulfides | 17.9 | 23.2 |
| Polars | 3.6 | 3.5 |
| Asph | 42.4 | 49.0 |
| MCR | 40.8 | 47.1 |
| % S | 6.6 | 8.1 |
| ppm Ni | 167 | 191 |
| ppm V | 891 | 1001 |

It can be seen that the membrane separation is not as tight as would be expected from propane deasphalting. Put another way, the modeled C3 deasphalting removes more metals and MCR, but fewer saturates. This fact may actually be advantageous, however, as the retentate product in a membrane separation will possess more solvent molecules then a C3-asphalt and would likely flow better without the need for flux.

### Example 7: Permeate Vs. Retentate Compositional Data for Separation of Arab Light Crude Using Various Membranes

Samples of Arab Light whole crude was separated using an Evonik Puramem 600 polymeric membrane and an 8 kD ceramic membrane at a temperature of 100° C. and transmembrane pressures of 600 psig. The Arab Light sample was run through the membrane to produce a 75% permeate yield by weight on feed. The results below were calculated based bulk property measurements and known composition of the feed. The results are depicted in Tables 6 and 7 below.

TABLE 6

| Arab Light | Feed | Permeate | Retentate |
|---|---|---|---|
| (Evonik 600) | (wt %) | (wt %) | (wt %) |
| Saturates | 43.590 | 50.483 | 19.819 |
| Saturates with MW < 250 | 27.000 | 33.062 | 6.092 |
| Paraffins | 25.658 | 30.985 | 7.289 |
| Paraffins with MW < 250 | 18.520 | 22.756 | 3.914 |
| Aromatics | 55.178 | 48.318 | 78.836 |
| Aromatics with MW > 500 | 19.768 | 8.876 | 57.347 |
| All Rings | 74.201 | 68.846 | 92.667 |
| All Rings with MW > 500 | 24.586 | 12.278 | 67.045 |

TABLE 7

| | Feed | Permeate | Retentate |
|---|---|---|---|
| Arab Light (ceramic 8 kD) | (wt %) | (wt %) | (wt %) |
| Saturates | 51.380 | 60.435 | 23.773 |
| Saturates with MW < 250 | 31.713 | 40.282 | 5.589 |
| Paraffins | 32.004 | 39.218 | 10.010 |
| Paraffins with MW < 250 | 22.633 | 28.886 | 3.568 |
| Aromatics | 46.570 | 37.652 | 73.759 |
| Aromatics with MW > 500 | 20.037 | 8.706 | 54.580 |
| All Rings | 67.720 | 60.453 | 89.873 |
| All Rings with MW > 500 | 24.969 | 11.979 | 64.572 |

As shown, the permeate stream is predominantly comprised of saturates and paraffins, and is especially high in saturates and paraffins that have a molecular weight less than 250. Conversely, the retentate stream is predominantly comprised of aromatics or other ringed molecules, and is especially high in aromatics or other ringed molecules with a molecular weight greater than 500. Put another way, the retentate product retains only about 10-15% of all saturates, 5-10% of all paraffins, about 3-10% of saturates with a molecular weight less than 250, and about to 3-6% of paraffins with a molecular weight less than 250. The permeate product, on the other hand, as compared to the feed, is reduced in aromatics by 30-40%, in other ringed molecules by 25-35%, in aromatics with a molecular weight greater than 500 by 65-75%, and in other ringed molecules with a molecular weight greater than 500 by 65-70%.

### Example 8: Permeate Vs. Retentate Compositional Data for Separation of Maya Crude Using Various Membranes

Samples of Maya whole crude was separated using an 8 kD ceramic membrane at a temperature of 200° C. and transmembrane pressures of 600 psig. The Maya sample was run through the membrane to produce a 50% permeate yield by weight on feed. Maya crude is heavy and thus higher temperatures are required to increase flux through the membrane. The results are depicted in Table 8 below.

TABLE 8

| | Feed | Permeate | Retentate |
|---|---|---|---|
| Maya (ceramic 8 kD) | (wt %) | (wt %) | (wt %) |
| Saturates | 40.790 | 65.692 | 14.679 |
| Saturates with MW < 250 | 23.322 | 42.182 | 3.592 |
| Paraffins | 22.459 | 38.600 | 5.558 |
| Paraffins with MW < 250 | 15.249 | 28.102 | 1.808 |
| Aromatics | 52.541 | 25.525 | 80.881 |
| Aromatics with MW > 500 | 35.204 | 13.753 | 57.815 |
| All Rings | 76.891 | 60.335 | 94.227 |
| All Rings with MW > 500 | 42.258 | 21.600 | 64.013 |

As shown, the permeate stream is predominantly comprised of saturates and paraffins, and is especially high in saturates and paraffins that have a molecular weight less than 250. Conversely, the retentate stream is predominantly comprised of aromatics or other ringed molecules, and is especially high in aromatics or other ringed molecules with a molecular weight greater than 500. Put another way, the retentate product retains only about 15-20% of all saturates, 10-15% of all paraffins, about 5-10% of saturates with a molecular weight less than 250, and about 3-8% of paraffins with a molecular weight less than 250. The permeate product, on the other hand, as compared to the feed, is reduced in aromatics by 70-80%, in other ringed molecules to by 35-45%, in aromatics with a molecular weight greater than 500 by 75-85%, and in other ringed molecules with a molecular weight greater than 500 by 70-80%.

### ADDITIONAL EMBODIMENTS

### Embodiment 1

A method for deasphalting a raw crude comprising: producing a raw crude from a subterranean formation; introducing the raw crude to a membrane thereby producing a permeate stream and a retentate stream, wherein the permeate stream has a micro carbon residue content that is at least 70% lower than a micro carbon residue content of the raw crude.

### Embodiment 2

The method of embodiment 1, further comprising injecting the retentate stream into the subterranean formation.

### Embodiment 3

The method of any of the previous embodiments, further comprising adding at least one of a surfactant, alkali, and polymer to the retentate stream.

### Embodiment 4

The method of any of the previous embodiments, wherein the membrane is a ceramic membrane.

### Embodiment 5

The method of any of embodiments 1-3, wherein the membrane is a polymeric membrane.

### Embodiment 6

The method of any of the previous embodiments, wherein the membrane has a molecular weight cut-off about 8 kD.

### Embodiment 7

The method of claim any of the previous embodiments, wherein the membrane has an average pore size from about 0.001 to about 0.020 microns (μm).

### Embodiment 8

The method of claim any of the previous embodiments, wherein the membrane has an average pore size from about 0.002 to about 0.015 microns (μm).

### Embodiment 9

The method of any of the previous embodiments, wherein the membrane has an average pore size from about 0.005 to about 0.010 microns (μm).

### Embodiment 10

The method of any of the previous embodiments, further comprising transporting the permeate stream to at least one of a refinery, pipeline network, and storage facility.

### Embodiment 11

The method of any of the previous embodiments, wherein the membrane has a differential pressure across it from about 400 psi to about 3000 psi.

### Embodiment 12

The method of any of the previous embodiments, wherein the permeate stream has a micro carbon residue content that is at least 80% lower than a micro carbon residue content of the raw crude.

### Embodiment 13

The method of any of the previous embodiments, wherein the permeate stream has an inorganic metals content that is at least 60% lower than an inorganic metals content of the raw crude.

### Embodiment 14

The method of any of the previous embodiments, wherein an average boiling point of the retentate stream is from 500 to 700° F. higher than an average boiling point of the permeate stream.

### Embodiment 15

The method of any of the previous embodiments, wherein the retentate stream has a saturates content that is about 5-20 wt. % of the saturates content of the raw crude.

### Embodiment 16

The method of any of the previous embodiments, wherein the permeate stream has a content of aromatics with a molecular weight greater than 500 that is at least 70% lower than a content of aromatics with a molecular weight greater than 500 of the raw crude.

### Embodiment 17

The method of any of the previous embodiments, wherein the raw crude includes an amount of water, further comprising separating a portion of the water from the raw crude.

### Embodiment 18

A system for desasphalting a raw crude, comprising: a well in fluid communication with a subterranean crude oil formation; wherein the well produces a raw crude from the subterranean crude oil formation; a membrane assembly in fluid communication with the well; wherein the membrane assembly comprises a retentate zone, a membrane, and a permeate zone; a conduit connecting the retentate zone and the subterranean crude oil formation to inject a retentate stream from the retentate zone to the subterranean crude oil formation; and a conduit connecting the permeate zone and a downstream facility to transport a permeate stream from the permeate zone to the downstream facility.

### Embodiment 19

The system of embodiment 18, wherein the membrane is a ceramic membrane.

### Embodiment 20

The system of embodiment 18, wherein the membrane is a polymeric membrane.

### Embodiment 21

The system of any of embodiments 18-20, wherein the membrane has a molecular weight cut-off about about 8 kD.

### Embodiment 22

The system of any of embodiments 18-21, wherein the membrane has an average pore size from about 0.001 to about 0.020 microns (μm).

### Embodiment 23

The system of any of embodiments 18-22, wherein the membrane has an average pore size from about 0.002 to about 0.015 microns (μm).

### Embodiment 24

The system of any of embodiments 18-23, wherein the membrane to has an average pore size from about 0.005 to about 0.010 microns (μm).

### Embodiment 25

The system of any of embodiments 18-24, wherein the downstream facility is at least one of a refinery, pipeline network, and storage facility.

### Embodiment 26

The system of any of embodiments 18-25, wherein the membrane has a differential pressure across it from about 400 psi to about 3000 psi.

### Embodiment 27

The system of any of embodiments 18-26, wherein the permeate stream has a micro carbon residue content that is at least 70% lower than a micro carbon residue content of the raw crude.

### Embodiment 28

The system of any of embodiments 18-27, wherein the permeate stream has a micro carbon residue content that is at least 80% lower than a micro carbon residue content of the raw crude.

### Embodiment 29

The system of any of embodiments 18-2, wherein the permeate stream has an inorganic metals content that is at least 60% lower than an inorganic metals content of the raw crude.

### Embodiment 30

The system of any of embodiments 18-29, wherein an average boiling point of the retentate stream is from 500 to 700° F. higher than an average boiling point of the permeate stream.

1. A method for deasphalting a raw crude comprising:
producing a raw crude from a subterranean formation;
introducing the raw crude to a membrane thereby producing a permeate stream and a retentate stream, wherein the permeate stream has a micro carbon residue content that is at least 70% lower than a micro carbon residue content of the raw crude.

2. The method of claim 1, further comprising injecting the retentate stream into the subterranean formation.

3. The method of claim 2, further comprising adding at least one of a surfactant, alkali, and polymer to the retentate stream.

4. The method of claim 1, wherein the membrane is a ceramic membrane.

5. The method of claim 1, wherein the membrane is a polymeric membrane.

6. The method of claim 5, wherein the membrane has a molecular weight cut-off about about 8 kD.

7. The method of claim 1, wherein the membrane has an average pore size from about 0.001 to about 0.020 microns (μm).

8. The method of claim 1, wherein the membrane has an average pore size from about 0.002 to about 0.015 microns (μm).

9. The method of claim 1, wherein the membrane has an average pore size from about 0.005 to about 0.010 microns (μm).

10. The method of claim 1, further comprising transporting the permeate stream to at least one of a refinery, pipeline network, and storage facility.

11. The method of claim 1, wherein the membrane has a differential pressure across it from about 400 psi to about 3000 psi.

12. The method of claim 1, wherein the permeate stream has a micro carbon residue content that is at least 80% lower than a micro carbon residue content of the raw crude.

13. The method of claim 1, wherein the permeate stream has an inorganic metals content that is at least 60% lower than an inorganic metals content of the raw crude.

14. The method of claim 1, wherein an average boiling point of the retentate stream is from 500 to 700° F. higher than an average boiling point of the permeate stream.

15. The method of claim 1, wherein the retentate stream has a saturates content that is about 5-20 wt. % of the saturates content of the raw crude.

16. The method of claim 1, wherein the permeate stream has a content of aromatics with a molecular weight greater than 500 that is at least 70% lower than a content of aromatics with a molecular weight greater than 500 of the raw crude.

17. The method of claim 1, wherein the raw crude includes an amount of water, further comprising separating a portion of the water from the raw crude.

18. A system for desasphalting a raw crude, comprising:
a well in fluid communication with a subterranean crude oil formation; wherein the well produces a raw crude from the subterranean crude oil formation;
a membrane assembly in fluid communication with the well; wherein the membrane assembly comprises a retentate zone, a membrane, and a permeate zone;
a conduit connecting the retentate zone and the subterranean crude oil formation to inject a retentate stream from the retentate zone to the subterranean crude oil formation; and
a conduit connecting the permeate zone and a downstream facility to transport a permeate stream from the permeate zone to the downstream facility.

19. The system of claim 18, wherein the membrane is a ceramic membrane.

20. The system of claim 18, wherein the membrane is a polymeric membrane.

21. The system of claim 20, wherein the membrane has a molecular weight cut-off about about 8 kD.

22. The system of claim 18, wherein the membrane has an average pore size from about 0.001 to about 0.020 microns (μn).

23. The system of claim 18, wherein the membrane has an average pore size from about 0.002 to about 0.015 microns (μn).

24. The system of claim 18, wherein the membrane has an average pore size from about 0.005 to about 0.010 microns (μn).

25. The system of claim 18, wherein the downstream facility is at least one of a refinery, pipeline network, and storage facility.

26. The system of claim 18, wherein the membrane has a differential pressure across it from about 400 psi to about 3000 psi.

27. The system of claim 18, wherein the permeate stream has a micro carbon residue content that is at least 70% lower than a micro carbon residue content of the raw crude.

28. The system of claim 18, wherein the permeate stream has a micro carbon residue content that is at least 80% lower than a micro carbon residue content of the raw crude.

29. The system of claim 18, wherein the permeate stream has an inorganic metals content that is at least 60% lower than an inorganic metals content of the raw crude.

30. The system of claim 18, wherein an average boiling point of the retentate stream is from 500 to 700° F. higher than an average boiling point of the permeate stream.
